(19) United States
(12) Patent Application Publication
(10) Pub. No.: US 2021/0395505 A1
(43) Pub. Date: Dec. 23, 2021

(54) A THERMOPLASTIC VULCANATE-LIKE MATERIAL

(71) Applicant: Dow Global Technologies LLC, Midland, MI (US)

(72) Inventors: Parvinder S. Walia, Midland, MI (US); Amit K. Chaudhary, Missouri City, TX (US)

(21) Appl. No.: 17/285,412

(22) PCT Filed: Oct. 15, 2019
(86) PCT No.: PCT/US2019/056223

§ 371 Date: Apr. 14, 2021

Related U.S. Application Data
(60) Provisional application No. 62/752,731, filed on Oct. 30, 2018.

(51) Int. Cl. C08L 23/26; C08J 3/12

(52) U.S. Cl. CPC C08L 23/26; C08L 2312/08; C08J 2323/26; C08J 3/12

(57) ABSTRACT

A composition for forming crosslinked polyolefin particles of micron or submicron size dispersed in an aqueous phase including: (i) water for forming an aqueous phase; (ii) a polyolefin polymer; and (iii) a curing agent for crosslinking the polyolefin polymer to form polyolefin particles of micron or submicron size dispersed in the aqueous phase of component (i); an aqueous dispersion crosslinked polyolefin particles of micron or submicron size dispersed in an aqueous phase; a powder material made from the above aqueous dispersion; a thermoplastic vulcanate (TPV)-like material made from the above powder; and an article made from the above TPV-like material

### FIELD

The present invention relates to crosslinked micron or submicron size polyolefin particles and a composition containing the crosslinked micron or submicron size polyolefin particles such that the composition has properties, and performs, significantly similar to a thermoplastic vulcanate (TPV) material.

### BACKGROUND

The automotive industry is continually seeking developments in haptics (of or relating to the sense of touch) and super low gloss (grain retention) for automotive interiors such as non-carpet flooring (NCF); flooring mats, and soft skins (e.g., instrument and door panels). Processes for preparing most of the above automotive products or articles typically involve sheet extrusion/calendering followed by thermoforming; and such processes require high melt strength materials, especially for deep draw. The low gloss (e.g., 60° degree less than 1) property of the above-mentioned automotive articles is commonly obtained through the use of grained surfaces and specialized materials. When using, for example, a positive vacuum forming (PVF) method, grain is imparted to the article during the sheet extrusion step of the process; and a key requirement for imparting low gloss is for the grain to be significantly retained during the thermoforming step of the process.

A thermoplastic vulcanate (TPV) material is known in the art as a blend of (1) a polyolefin, such as polypropylene (PP) and (2) a rubber, such as ethylene propylene diene monomer (EPDM). The TPV is capable of being partially or fully crosslinked using a curing agent such as peroxide. TPVs are typically made by a “dynamic vulcanization” process where PP and EPDM are blended together in the presence of the curing agent (e.g., peroxide). The peroxide crosslinks the EPDM phase and the peroxide “visbreaks” the PP phase; and these actions by the peroxide leads to a phase inversion where the EPDM becomes a dispersed phase as crosslinked droplets (e.g., in the range of from 1 micron (μm) to 10 μm) in a PP continuous phase.

Processes for making conventional TPVs are well known; and are described, for example, in U.S. Pat. Nos. 4,130,535 and 4,311,628. Also, U.S. Pat. No. 6,388,016 discloses a process for producing a TPV wherein a polymer blend is produced by solution polymerization in a series of reactors employing a metallocene catalyst (other prior art processes use a vanadium catalyst, for example as disclosed in U.S. Pat. Nos. 3,639,212 and 4,016,342). The process of U.S. Pat. No. 6,388,016 uses a direct polymerization process where the product from a first reactor is fed to a second reactor. The resultant blend is subjected to dynamic vulcanization by adding a curing agent to the resultant blend under conditions of heat and shear sufficient to cause the blend to flow and sufficient to at least partially crosslink the diene-containing polymer. The dynamic vulcanization process forms a dispersion of cured diene-containing particles in a matrix of PP. The process of U.S. Pat. No. 6,388,016 still relies on dynamic vulcanization to cure the elastomeric component. As a result of dynamic vulcanization used in the above known process, the cured diene-containing particles have an average particle size in the range of 1 μm to 10 μm.

Conventional TPVs (due to the presence of the crosslinked particles) provide superior performance when used in the above-mentioned automotive applications. The crosslinked particles of the crosslinked phase of TPVs impart high melt strength to TPVs and the crosslinked phase is particularly advantaged for grain retention during PVF. However, TPVs are typically expensive and suffer from poor odor and high volatile organic compounds (VOCs) (usually because of the peroxide used as the curing agent in the composition).

It is desired to provide a TPV-like material that performances as well as, or better than, conventional TPVs; and that does not have the disadvantages of poor odor and high VOCs. It is also desired to provide a process for making the TPV-like material by using a simple blending operation rather than using a more complex compounding process of the prior art.

### SUMMARY

In one embodiment, the present invention is directed to a composition for forming crosslinked polyolefin particles of micron or submicron size dispersed in an aqueous phase including:(i) water for forming an aqueous phase; (ii) a polyolefin polymer; and (iii) a curing agent for crosslinking the polyolefin polymer to form polyolefin particles of micron or submicron size dispersed in the aqueous phase of component (i).

In another embodiment, the present invention includes a process for producing the above composition for forming crosslinked polyolefin particles of micron or submicron size dispersed in an aqueous phase.

In still another embodiment, the present invention is directed to an aqueous dispersion composition including: (a) water for forming an aqueous phase; and (b) crosslinked polyolefin particles of micron or submicron size dispersed in the aqueous phase of component (a). In a preferred embodiment, the above crosslinked polyolefin particles of micron or submicron size are derived from crosslinking a polyolefin polymer via moisture cure using a silane grafted or silane copolymer polyolefin particle

In yet another embodiment, the above crosslinked polyolefin particles of micron or submicron size are derived from crosslinking a polyolefin polymer via radical cure—Ebeam or peroxide or ultraviolet (UV) cure via incorporation of UV curable additives

In yet another embodiment, the present invention includes a process for producing an aqueous dispersion of crosslinked polyolefin particles of micron or submicron size.

In even still another embodiment, the present invention is directed to a process for producing a powder material of dried crosslinked polyolefin particles of micron or submicron size.

In even yet another embodiment, the present invention includes powder material of dried crosslinked polyolefin particles of micron or submicron size produced by the above process.

In another embodiment, the present invention includes a thermoplastic vulcanate-like polymeric composition including a blend of (I) at least one polymer; and (II) the above powder material.

In still another embodiment, the present invention includes a process for producing the above thermoplastic vulcanate-like polymeric composition.

In yet another embodiment, the present invention includes an article produced from the above thermoplastic vulcanate-like polymeric composition.

In even still another embodiment, the present invention includes a process for producing the above article.

The present invention provides a beneficial TPV-like material composition that has similar or better performance properties/characteristics of a conventional TPV material derived from crosslinked polyolefin particles having a micron or submicron particle size.

### BRIEF DESCRIPTION OF THE DRAWINGS

FIG. 1 is a graphical illustration showing the particle size distribution of a polyolefin dispersion.

FIG. 2 is another graphical illustration showing the particle size distribution of a silane grafted polyolefin dispersion.

FIG. 3 are TEM micrographs showing the morphology of ENGAGE DA50 compounds at a magnification of 2 μm; wherein the compound shown in micrograph: (A) contains non-crosslinked HYPOD bead particles, (B) contains Ebeam HYPOD particles, and (C) contains ENGAGE 8200.

FIG. 4 is a graphical illustration showing the extensional viscosity at 160° C. of four different samples compositions.

FIG. 5 are TEM micrographs showing the morphology, at a magnification of 2 μm; wherein the compound shown in micrograph is: (A) a cured control ENGAGE compound containing polypropylene particles dispersed in the compound, (B) a cured ENGAGE compound containing Ebeam bead particles dispersed in the compound, and (C) a cured ENGAGE compound containing silane bead particles dispersed in the compound.

FIG. 6 is a photograph showing the gloss up after thermoforming of an ENGAGE DA50 composition; wherein the thermoform article of: (A) contains 30 weight percent (wt %) silane beads, (B) contains 30 wt % Ebeam beads, (C) contains no beads.

### DETAILED DESCRIPTION

In one broad scope embodiment, the present invention relates to crosslinked micron or submicron size polyolefin particles and a composition containing the crosslinked micron or submicron size polyolefin particles such that the present invention composition has properties, and performs, significantly similar to a thermoplastic vulcanate (TPV) material. Accordingly, the present invention provides a TPV-like material. A “thermoplastic vulcanate (TPV)-like material”, with reference to the composition of the present invention, herein means a material incorporated crosslinked polyolefin particles in the micron or sub-micron size; that exhibits TPV-like performance such as low gloss, high melt strength, and the ability to maintain grain during positive thermoforming; low compression set, improved wear and abrasion resistance. “Micron or submicron size”, with reference to particles, herein means a particle with an average particle size of from 0.5 micron (μm) up to 10 μm.

The aqueous composition for forming crosslinked polyolefin particles of micron or submicron size dispersed in an aqueous phase includes a blend of (i) water for forming an aqueous phase; (ii) a polyolefin-polymer; and (iii) a curing agent for crosslinking the polyolefin polymer to form polyolefin particles of micron or submicron size dispersed in the aqueous phase of component (i).

Component (i) of the aqueous composition is water. The amount of water used to form the aqueous composition can be generally in the range of from 30 wt % to 70 wt % in one embodiment; from 40 wt % to 65 wt % in another embodiment; and from 50 wt % to 60 wt % in still another embodiment, based on the total weight of the components in the composition.

The polyolefin polymer of the aqueous composition may include, for example, one or more polyolefins. For example, the polyolefin can include a silane grafted polyolefin or a silane copolymer to enable moisture cure.

In one general embodiment, the polyolefins useful in the present invention can include, for example, low density polyethylene (LDPE); linear low density polyethylene (LLDPE); high density polyethylene (HDPE); polypropylene (PP); copolymers such as alpha olefin-ethylene, ethylene-propylene, ethylene propylene diene copolymer (EPDM), ethylene vinyl acetate (EVA), ethylene vinyl alcohol (EVOH) can be used when radical cure is utilized (e.g., Ebeam, peroxide or when UV cure is utilized); and mixtures thereof.

In a preferred embodiment, the polyolefin useful in the present invention may include, for example, (a) silane grafted polyolefin or a silane copolymer (b) a high flow polyolefin (>10 melt flow rate [MFR]) or a functional polyolefin (to enable reduced elastomer particle size). The functional polyolefin can include a maleic anhydride (MAH) grafted polyolefin (e.g., ENGAGE™, INTUNE™, and VERSIFY™ all of which are available from The Dow Chemical Company); ethylene acrylic acid and methacrylic acid copolymers (e.g., NUCREL™ available from DuPont and PRIMACOR™ available from SK Chemicals); ethylene acrylate (e.g., methyl acrylate, ethyl acrylate, butyl acrylate, and glycidyl methacrylate) (e.g., ELVALOY™ available from DuPont); ethylene vinyl alcohol (EVOH) ionomers of sodium and zinc neutralized acrylic copolymers (e.g., SURYLN™ available from DuPont); and mixtures thereof.

Exemplary of the polyolefin compounds useful in the present invention can include (a) Silink ethylene copolymer or a silane grafted polyolefin such as silane grafted LDPE, LLDPE, HDPE, PP or ethylene octene random polymer (e.g., ENGAGE™); a block copolymer (e.g., INFUSE™ available from The Dow Chemical Company); an ethylene propylene copolymer (e.g., VERSIFY™ and INTUNE™); and mixtures thereof. Ethylene propylene diene copolymer (EPDM), ethylene vinyl acetate (EVA)\, ethylene vinyl alcohol (EVOH), and mixtures thereof.

The amount of the polyolefin polymer present in the aqueous composition can be generally in the range of from 40 wt % to 99 wt % in one embodiment; from 50 wt % to 95 wt % in another embodiment; and from 60 wt % to 90 wt % in still another embodiment, based on the weight of the total components in the aqueous composition.

Also, the polymeric phase can include, in addition to the first surfactant described above, more than one type of surfactant (e.g., PRIMACOR™) surfactants may include, for example, low MW aliphatic (C15-C45) carboxylic acid (e.g., UNICID™ available from Baker Hughes) MAH grafted polyolefins (e.g., AMPLIFY™ available from The Dow Chemical Company and FUSABOND™ available from Dupont); and mixtures thereof.

In other embodiments, the dispersing agent is selected from alkyl ether carboxylates, petroleum sulfonates sulfonated polyoxyethylenated alcohol, sulfated or phosphated polyoxyethylenated alcohols, polymeric ethylene oxide/propylene oxide/ethylene oxide dispersing agents, primary and secondary alcohol ethoxylates, alkyl glycosides and alkyl glycerides

In addition, polymeric surfactants such as ethylene acrylic acid copolymers—EAA, ethylene methacrylic acid copolymers—MAA, and mixtures thereof can be added to the TPV-like composition of the present invention.

For example, a commercially available surfactant useful in the present invention can be PRIMACOR™, NUCREL™ and mixtures thereof. Synthetic surfactants may also be used in the composition.

Other compounds such as fatty acids, C16-50 (oleic acid, linear long chain carboxylic, UNICID™, can also be included in the TPV-like composition.

Functional resins such as MAH, hydroxyl (OH) and amine functional can also be used in the present invention as dispersants/compatibilizer.

The solids content of the composition can be, for example, from 20 wt % to 70 wt % solids content in one embodiment, from 30 wt % to 60 wt % in another embodiment, and from 40 wt % to 50 wt % in still another embodiment.

A neutralizing agent can be used in the composition of the present invention, including for example, KOH, NaOH, DMEA, ammonia and mixtures thereof. When a neutralizing agent is used the degree of neutralization during the dispersion process can be for example, from 50 wt % to 150 wt % in one embodiment, from 70 wt % to 130 wt % in another embodiment, and from 80 wt % to 110 wt % in still another embodiment, based on the total weight of the components in the composition.

The curing agent or crosslinking agent used in the aqueous composition includes for example, an acid or tin catalyst, and mixtures thereof. In a preferred embodiment, the curing agent useful in the present invention may include for example dodecylbenzene sulfonic acid (DBSA).

The amount of the curing agent/crosslinking agent present in the aqueous composition can be generally in the range of from 0.1 wt % to 1 wt % in one embodiment; from 0.2 wt % to 0.8 wt % in another embodiment; and from 0.3 wt % to 0.7 wt % in still another embodiment, based on the weight of the total components in the aqueous composition.

Optional compounds or additives, as additional functional components, may be added to the aqueous formulation or composition of the present invention; and such optional compounds may include, for example, other catalysts, surfactants, toughening agents, flow modifiers, adhesion promoters, diluents, stabilizers, plasticizers, catalyst de-activators, flame retardants, liquid and solid nucleating agents, solid nucleating agents, pigments, and mixtures thereof.

The amount of the optional compounds or additives present in the aqueous composition, when used, can be generally in the range of from 0 wt % to 20 wt % in one embodiment; from 0.01 wt % to 10 wt % in another embodiment; and from 0.1 wt % to 5 wt % in still another embodiment, based on the weight of the total components in the aqueous composition.

In one embodiment of a broad scope, the process for producing the aqueous composition described above for forming crosslinked polyolefin particles of micron or submicron size dispersed in an aqueous phase includes admixing: (i) water for forming an aqueous phase; (ii) a polyolefin polymer; and (iii) a surfactant to form polyolefin particles of micron or submicron size dispersed in the aqueous phase of component (i).

Generally, the amount of the surfactant, component used in the formulation of the present invention can be generally for example greater than 1 wt % to 50 wt % in one embodiment; from 2 wt % to 40 wt % in still another embodiment; and from 3 wt % to 30 wt % in yet another embodiment; based on the total weight of all components in the polymer phase

Generally, the step of admixing the (i) water for forming an aqueous phase; (ii) a polyolefin polymer; and (iii) a surfactant composition using the method described in U.S. Pat. Nos. 7,803,865 and 7,763,676. The extruder based mechanical dispersion process imparts high shear on a polymer melt/water mixture to facilitate a water continuous system with small polymer particles in the presence of surface active agents that reduce the surface tension between the polymer melt and water. A high solids content water continuous dispersion is formed in the emulsification zone of the extruder also known as high internal phase emulsion (HIPE) zone, which is then gradually diluted to the desired solids concentration, as the HIPE progresses from the emulsification zone to the first and second dilution zones.

The polyolefin polymer is fed into the feed throat of the extruder by means of a loss-in weight feeder. The dispersion agent is added with the polyolefin polymer. The extruder and its elements are made of nitrided carbon steel. The extruder screw elements are chosen to perform different unit operations as the ingredients pass down the length of the screw. There is first a mixing and conveying zone, next an emulsification zone, and finally a dilution and cooling zone. Steam pressure at the feed end is contained by placing kneading blocks and blister elements between the melt mixing zone and was contained and controlled by using a back-pressure regulator.

For the silane approach, the curing agent (acid) is added after the dispersion is made to avoid curing during the dispersion process. The ingredients that make up the aqueous composition may be mixed together by various mixing processes and equipment well known in the art.

The aqueous composition of the present invention may have several advantageous properties and benefits such as narrow particle size distribution; stable particles, and low viscosity. For example, the particle size distribution of the aqueous composition, as measured by a Coulter LS230 particle analyzer, consisted of an average volume diameter in microns of from 0.3 μm to 10 μm in one embodiment; from 0.4 μm to 7 μm in another embodiment; and from 0.5 μm to 4 μm in still another embodiment. “Stable” particles can be measured, for example, by light scattering, laser diffraction or zeta potential method.

For example, the viscosity of the aqueous composition, as measured according to a conventional method using a Brookfield Viscometer. can be from 50 centipoise (cps) to 600 cps in one embodiment; from 80 cps to 400 cps in another embodiment; and from 100 cps to 300 cps in still another embodiment.

Other embodiments within the scope of the present invention will become apparent to one skilled in the art and can include, for example, changing the ingredients of the aqueous composition to provide the aqueous composition with a desired property or beneficial performance.

In another broad embodiment, the present invention includes an aqueous dispersion composition of crosslinked polyolefin particles of micron or submicron size dispersed in an aqueous phase. The aqueous dispersion composition includes, for example, (a) water for forming an aqueous phase; and (b) crosslinked polyolefin particles of micron or submicron size dispersed in the aqueous phase of component (a). The crosslinked polyolefin particles of micron or submicron size dispersed in the aqueous dispersion composition of the above embodiment can be derived from crosslinking the polyolefin polymer described above with the curing agent described above.

The process for making the aqueous dispersion of crosslinked polyolefin particles of micron or submicron size includes the steps of:

(A) admixing: (i) water for forming an aqueous phase; (ii) a polyolefin polymer; and (iii) a curing agent for crosslinking the polyolefin polymer to form polyolefin particles of micron or submicron size dispersed in the aqueous phase of component (i); and

(B) crosslinking the dispersed polyolefin polymer in the admixture from step (A) to form an aqueous dispersion of crosslinked polyolefin particles of micron or submicron size dispersed in the aqueous dispersion.

In general, the crosslinking step to form the crosslinked polyolefin particles of micron or submicron size in the aqueous dispersion composition can be carried out under the following process. For example, in preparing the aqueous dispersion composition, the crosslinking step can be carried out at a temperature of from 20° C. to 95° C. in one embodiment; from 30° C. to 90° C. in another embodiment; and from 40° C. to 80° C. in still another embodiment.

The degree of cure of the crosslinking step can be, for example, at a gel level of from 20% to 90% gel level in one embodiment, from 30% to 80% in another embodiment, and from 40% to 70% in still another embodiment.

In the curing step, silane moisture curing and an acid or tin-based catalyst can be used. For example, the acid catalyst can be metal salts of carboxylic acids; and mixtures thereof. The base can be organic bases, and inorganic and organic acids. Exemplary of the metal carboxylates can be di-n-butyldilauryl tin (DBTDL); and mixtures thereof. Exemplary of the organic bases can be pyridine; and mixtures thereof. Exemplary of the inorganic acids can be sulfuric acid; and mixtures thereof. And, exemplary of the organic acids can be toluene disulfonic acid, naphthalene disulfonic acid; and mixtures thereof.

The aqueous dispersion containing the crosslinked particles of micron or submicron size of the present invention may have several advantageous properties and benefits such as narrow particle size distribution; stable particles and low viscosity as described above.

In a general embodiment, the powder material useful for forming a TPV-like material includes a concentration of dried crosslinked polyolefin particles of micron or submicron size which result from drying the aqueous dispersion containing the crosslinked particles of micron or submicron size described above.

In one embodiment, the process for producing a powder material of dried crosslinked polyolefin particles of micron or submicron size can include the steps of:

(A) admixing: (i) water for forming an aqueous phase; (ii) a polyolefin polymer; and (iii) a curing agent for crosslinking the polyolefin polymer to form polyolefin particles of micron or submicron size dispersed in the aqueous phase of component (i); and

(B) crosslinking the dispersed polyolefin polymer in the admixture from step (A) to form polyolefin particles of micron or submicron size dispersed in an aqueous dispersion; and

(C) drying the aqueous dispersion containing the crosslinked polyolefin particles of micron or submicron size of step (B) to provide a material of dried crosslinked polyolefin particles in powder form.

The admixing step (A) of the process for making the powder material of crosslinked polyolefin particles of micron or submicron size has been described above.

The crosslinking step (B) of the process for making the powder material of crosslinked polyolefin particles of micron or submicron size has been described above.

In general, the drying step (C) to form the dried crosslinked polyolefin particles of micron or submicron size can be carried out under various process conditions depending on the application method used. For example, the drying step can include spray drying or coagulation drying (e.g., the coagulation process described in Examples), and other conventional drying techniques. In one embodiment for preparing the powder material, the drying step can be carried out at a temperature of from 50° C. to 150° C.; from 60° C. to 140° C. in another embodiment; and from 70° C. to 120° C. in still another embodiment. In other embodiments, the cured dispersion particles can be separated into a powder using for example spray drying; coagulation; filtration and centrifugation; and freeze drying.

The powder material of the crosslinked particles of micron or submicron size of the present invention may have several advantageous properties and benefits. For example, the particles are “free flowing” and will flow without blocking; and the particles are capable of being broken down to primary particle size with low shear. Also, sophisticated mixing equipment is not required to disperse the powder).

The particle size of the dried powder of polyolefin particles can be generally in the range of from 1 micron (μm) to 700 μm in one embodiment; from 20 μm to 500 μm in another embodiment; and from 50 μm to 300 μm in still another embodiment.

In another broad scope embodiment of the present invention a thermoplastic vulcanate (TPV)-like polymeric composition is provided including an admixture or at least a two-component blend of: (I) the powder material described above; and (II) at least one polymer. In a preferred embodiment, the vulcanate-like composition includes a blend of: (I) the powder material described above; and (II) a polymer compound such as a polyolefin; wherein the blend results in a material blend composition that performs similar to a thermoplastic vulcanate composition. The vulcanate-like material includes at least a two-component blend of: (i) the crosslinked polyolefin particles in powder form described above and (ii) a polyolefin material to form a thermoplastic vulcanate (TPV)-like performing material blend composition. The TPV-like composition may also include more than two components to form the blend.

The powder material, i.e., the dried crosslinked polyolefin particles in powder form, useful in the TPV-like composition has been described above.

The amount of the powder material present in the TPV-like composition can be generally in the range of from 1 wt % to 90 wt % in one embodiment; from 10 wt % to 70 wt % in another embodiment; and from 30 wt % to 60 wt % in still another embodiment, based on the weight of the total components in the composition.

In general, the amount of cured polyolefin particles of the powder material that can be used in an application may depend on the function intended for various applications. For example, when the cured polyolefin particles are used as an additive in flooring and skin applications that utilize a positive or negative thermoforming process, the range of cured polyolefin particles to be used can be from 1% to 90% in one embodiment, from 20% to 60% in another embodiment, and from 25% to 40% in still another embodiment.

One or more polymer compounds can be used in the TPV-like polymeric composition of the present invention. The polymer compounds may be selected, for example, from the following compounds: polyolefins such as LDPE, LLDPE, HDPE, PP or ethylene octene random polymer (e.g., ENGAGE and INFUSE); an ethylene propylene copolymer (e.g., VERSIFY and INTUNE); and mixtures thereof. Ethylene propylene diene copolymer (EPDM), ethylene vinyl acetate (EVA), ethylene vinyl alcohol (EVOH) can also be useful in the present invention. The polymers can also include functional polyolefins, for example, MAH grafted polyolefin (e.g., MAH grafted ENGAGE, INTUNE or VERSIFY), ethylene acrylic acid and methacrylic acid copolymers (e.g., NUCREL and PRIMACOR), ethylene acrylate (e.g., methyl acrylate, ethyl acrylate, butyl acrylate and glycidyl methacrylate) (e.g., ELVALOY); ethylene vinyl alcohol (EVOH) ionomers of sodium and zinc neutralized acrylic copolymers (SURYLN); and mixtures thereof. In a preferred embodiment, the polymer compound useful in the present invention may include for example, one or more of the above polyolefins.

The amount of the polymer compound, such as a polyolefin, present in the TPV-like composition can be generally in the range of from 10 wt % to 99 wt % in one embodiment; from 30 wt % to 90 wt % in another embodiment; and from 40 wt % to 60 wt % in still another embodiment, based on the weight of the total components in the composition.

A typical TPV-like composition may contain optional ingredients, additives or compounds such as fillers or liquid processing oils, or other functional chemicals for any intended applications. For example, the optional compounds or additives, as additional functional components, may be added to the TPV-like formulation or composition of the present invention; and such optional compounds may include, for example, other catalysts, surfactants, toughening agents, flow modifiers, adhesion promoters, diluents, stabilizers, plasticizers, catalyst de-activators, flame retardants, liquid and solid nucleating agents, solid nucleating agents, fillers, additives, pigments, and mixtures thereof.

The amount of the optional compounds or additives present in the final TPV-like composition, when used, can be generally in the range of from 0 wt % to 30 wt % in one embodiment; from 0.01 wt % to 25 wt % in another embodiment; and from 0.1 wt % to 15 wt % in still another embodiment, based on the weight of the total components in the TPV-like composition.

In one preferred embodiment, the polyolefin resin used to make the TPV-like composition may include, for example, a silane copolymer or a silane grafted polyolefin (60-97%).

In another broad embodiment, the process for making the vulcanate-like material (the two-component blend composition) of the present invention includes, for example, admixing or blending: (α) the powder material described above; and (β) the at least one polymer as described above, such as a polyolefin. Beneficially, the blend results in a TPV-like material blend composition that performs similar to a thermoplastic vulcanate composition.

The components (α) and (β) to make the TPV-like blend composition can be mixed together in a vessel; and mixed in conventional mixing equipment and under conventional mixing conditions as known in the art (e.g., extruders). One or more additional optional compounds may be added to the composition as desired.

Generally, the mixing of the components (α) powder material; and (β) polymer(s) that make up the blend TPV-like composition can be carried out at a temperature of from 120° C. to 280° C. in one embodiment, from 150° C. to 250° C. in another embodiment, and from 180° C. to 220° C. in still another embodiment.

In another embodiment, the crosslinked polyolefin particles of the present invention can be blended into polypropylene (PP) for impact modification to create a TPO.

In still another embodiment, the crosslinked polyolefin particles can be used as a modifier in polar materials such as Nylon, polyester, PVC, acrylics, styrenics, PC/ABS and the like.

In yet another embodiment, expandable microspheres or chemical blowing agents can be made by incorporating (e.g., azodicarbonamide or sodium bicarbonate) inside the crosslinked polyolefin particles while making the dispersion. This embodiment, provides a process or mechanism for creating a foamable bead for example.

The blend TPV-like composition of the present invention has several beneficial properties and performances. For example, the composition can have properties such as high melt strength, improved thermoformability, low gloss, high degree of grain retention, low compression set, improved abrasion and scratch performance.

The high melt strength of the TPV-like composition can be, for example, from 150,000 Pa-s to 1,000,000 Pa-s in one embodiment, from 200,000 Pa-s to 900,000 Pa-s in another embodiment, and from 250,000 Pa-s to 800,000 Pa-s in still another embodiment. The high melt strength of the TPV-like composition can be measured using the extensional viscosity (EVF) method (0.1 rad/s and at 1 Hencky strain) as described in the “General Procedure for Measuring Extensional Viscosity” set forth in the Examples herein below.

The thermoformability of the TPV-like composition can be, for example, greater than 1.1 in one embodiment, greater than 1.25 in another embodiment, and greater than 1.5 in still another embodiment. The thermoformability of the TPV-like composition can be measured by using a ratio of elongational viscosity at 0.25 Hencky strain to the viscosity at 1 Hencky strain via the EVF method (measures elongation as a function of Hencky strain) described herein below. For thermoforming applications, it is desired that the elongational viscosity increases as the strain rate increases. Many parts may experience draw during thermoforming of up to 100% (1 Hencky strain). If the viscosity does not increase significantly as the part draws, then local thinning or tearing can occur in high draw areas.

The low gloss of the TPV-like composition can be, for example, less than 1.8 in one embodiment, less than 1.5 in another embodiment, and less than 1.0 in still another embodiment. The low gloss of the TPV-like composition can be measured by the method described as 60 degree gloss in ASTM D2457.

The high degree of grain retention of the TPV-like composition can be, for example, from 60% to 100% in one embodiment, from 70% to 100% in another embodiment, and from 80% to 100% in still another embodiment. The high degree of grain retention of the TPV-like composition can be measured by the % depth of grain after thermoforming as can readily be determined by those skilled in the art.

The low compression set of the TPV-like composition can be, for example, less than 60% to in one embodiment, less than 50% in another embodiment, and less than 40% in still another embodiment. The low compression set of the TPV-like composition can be measured by the method described in ASTM D395.

The abrasion and scratch performance of the TPV-like composition can be, for example, less than 40 mg weight loss in one embodiment, less than 20 mg weight loss in another embodiment, and less than 10 mg in another embodiment. The abrasion performance of the TPV-like composition can be measured by the method described in SAE J948 (CS10 wheel m 250 cycles, 500 gram weight).

One of the advantages of the present invention include capability of creating a controllable particle size of a polyolefin powder where the particle is crosslinked and has an initial primary particle size; and the powder can then be readily compounded into a formulation while maintaining the primary particle size of the powder particles. Hence, the present invention advantageously provides a novel route for producing, via physical blending, a blend composition that exhibits TPV-type performance.

In one preferred embodiment, the present invention provides a thermoplastic vulcanate (TPV) type material by the following steps:

Step (1): creating a desired polyolefin particle having a desired particle size in an aqueous phase using, for example a dispersion method such as BLUEWAVE™ dispersion technology;

Step (2): crosslinking the dispersed polyolefin particles from step (1) using a curing method such as silane moisture cure, radical cure via E-beam or peroxides, or UV cure and the like;

Step (3): drying the cured dispersion from step (2) to provide a powder using a drying method such as coagulation or spray drying and the like; and

Step (4): blending (i) the crosslinked polyolefin particles (in powder form) from step (3) with (ii) a polyolefin material, wherein the polyolefin material, component (ii) can be selected, for example, from: (iia) PP, PE, EP, EPR, EPDM and the like, or (iib) other polymers, including polar polymers such as polyamides, polyesters, thermoplastics urethanes, PVC, acrylics, styrenics, and the like; or (iic) mixtures thereof.

The present invention novel route advantageously provides a TPV type material with an accurate particle size at micron or submicron scale (e.g., 0.5 μm-10 μm) and a narrow particle size distribution. Obtaining a TPV type material with a proper particle size is enabled via the BLUEWAVE™ dispersion process. The particle size can be easily tuned via the BLUEWAVE™ dispersion process. The present invention particle size of 0.5 μm to 10 μm is advantageous because particles larger than the average wave length of visible light (˜542 nm) scatter a significant amount of light in both the forward and backward direction, whereas particles larger than 20 μm are practically inefficient as light scattering centers.

In addition to the above advantages, the present invention novel route advantageously provides a TPV type material that is advantageous over known TPVs because:

(1) The process of the present invention does not use a reactor for particle size control.

(2) The particle size and distribution of the present invention is accurately controlled using the BLUEWAVE™ dispersion process; whereas the morphology (particle size and shape) of prior art TPVs is an output of a compounding process. The process of the present invention uses an aqueous-based process such as BLUEWAVE™. The BLUEWAVE™ technology is a unique process described in U.S. Pat. Nos. 78,038,657 and 763,676 that can be used to provide the TPV performing-like materials of the present invention. The extruder based mechanical dispersion process imparts high shear on a polymer melt/water mixture to facilitate a water continuous system with small polymer particles in the presence of surface active agents that reduce the surface tension between the polymer melt and water. A high solids content water continuous dispersion is formed in the emulsification zone of the extruder also known as high internal phase emulsion (HIPE) zone, which is then gradually diluted to the desired solids concentration, as the HIPE progresses from the emulsification zone to the first and second dilution zones.

(3) The novel present invention process allows the right morphology to be obtained by simple blending and decouples the need for obtaining the right morphology (which is inherent to polymer molecular weight (MW) and molecular weight distribution (MWD), density and solubility parameter) by compounding; reactive extrusion or dynamic vulcanization.

(4) The level or degree of cure of the particles can be easily and accurately controlled using the process of the present invention.

(5) The present invention process provides the capability to disperse the cured powder back to a primary particle size in a simple blending operation rather than a more complex compounding process of the prior art.

(6) The present invention includes a route to crosslink particles in a dispersion and to isolate the particle in powder form which is a form that can be readily blended into any polyolefin or polymer product. The present invention also allows isolation of the particles produced, in powder form, that can be readily blended into a polyolefin in its original particle size.

(7) One more additional advantage of the present invention TPV-type composition materials over traditional TPVs is that the materials of the present invention have lower VOCs (e.g., when using E-beam, UV or silane moisture cure).

(8) Even if peroxide cure is used in the present invention process, a washing step can be used during coagulation to remove by-products of radical cure such that a significant reduction in odor and VOCs can be achieved.

(9) The present invention allows for a much smaller particle size to be produced and eliminates the need for dynamic vulcanization.

Once the (α) powder material; and (β) polymer(s) are mixed forming the blended TPV-like composition, the TPV-like composition is used to make an article or product. For example, and not to be limited thereby, an article can be made from the TPV-like blend composition of the present invention by admixing: (A) the two or more-component blend composition described above; and (B) one or more fillers (e.g., fibers, particles or nanoparticles) and processing oils. In one embodiment, the article can be, for example, a sheet extruded material that is subsequently thermoformed or calendared; or blow molded for use in an automotive application such as flooring; skins; and interior and exterior parts.

The amount of the powder material used to prepare an article such as a composite can be generally in the range of from 10 wt % to 90 wt % in one embodiment; from 20 wt % to 80 wt % in another embodiment; and from 30 wt % to 60 wt % in still another embodiment, based on the weight of the crosslinked polyolefin powder.

The additive or material, component (B), used in the final TPV-like composition can be for example substrates, particles, fibers, other additive materials, and mixtures thereof. The fibers can be, for example, carbon, glass, and mixtures thereof. The fillers can be, for example, talc, wollastonite, calcium or sodium carbonate, barium sulfate, and mixtures thereof.

The amount of the additive or material used in combination with the blend composition can be generally in the range of from 0.1 wt % to 70 wt % in one embodiment; from 0.5 wt % to 50 wt % in another embodiment; and from 1 wt % to 10 wt % in still another embodiment, based on the weight of total weight of the components in the composition.

The process for making an article from the blend composition can be carried out by any conventional methods and equipment known in the prior art for making shaped polymeric articles. For example, the method used herein may include sheet extrusion/calendaring, thermoforming, blow molding, injection and compression molding, and the like. In general, the process for preparing an article of the present invention includes sheet extrusion with a grained surface followed by positive thermoforming where the grain is substantially retained.

The article of the present invention has several beneficial thermal and/or mechanical performances and properties. For example, the article can have low gloss (60° degree); high melt strength (as measured by extensional viscosity); improved wear and abrasion resistance (as measured by Taber resistance).

The article or product made using the composition of the present invention may be used in various applications including, for example, in the automotive, packaging, wire & cable industries. In a preferred embodiment, the article or product is used for making floor mats for the automotive industry, and soft skins, and the like.

### EXAMPLES

The following examples are presented to further illustrate the present invention in detail but are not to be construed as limiting the scope of the claims. Unless otherwise stated all parts and percentages are by weight.

Various raw materials (ingredients or components) used in the Inventive Examples (Inv. Ex.) and the Comparative Examples (Comp. Ex.) which follow are described herein below in Table I.

TABLE I
Raw Materials

| INGREDIENT | DESCRIPTION | SUPPLIER |
|---|---|---|
| ENGAGE ™ | An ethylene octene random | The Dow |
| 8200 | copolymer; 0.89 density, 5 MFR | Chemical |
| | | Company |
| | | (Dow) |
| PRIMACOR | 20% acrylic acid, 0.958 density, | SK |
| 5980i | 300 MFR (190° C./2.16 Kg), | Chemicals |
| | melting point (Tₘ) = ~78° C. | |
| HYPOD ™ | A 60% ENGAGE ™ 8200 and | Dow |
| 8510 | 40% PRIMACOR 5980i mixture | Dispersion |
| SIILINK DFDA- | VTMS (Vinyl trimethoxy silane); | Dow |
| 5451 | 1.5 MFR, 0.922 density, 1.5% | |
| | VTMS | |
| PCN-727⁽¹⁾ | An experimental VTMS grafted | Dow |
| | ENGAGE ™; 6.5 MFR, 1.5% | |
| | VTMS | |
| ENGAGE ™ | An ethylene octene random | Dow |
| 8407 | copolymer; 0.89 density, 30 MFR | |
| ENGAGE 7280 | An ethylene octene high melt | Dow |
| | strength elastomer; 0.884 density, | |
| | <0.5 MFR | |
| ENGAGE ™ | A high melt strength elastomer: | Dow |
| DA50 | ENGAGE 7280 + 25% 35 MFR | |
| | polypropylene (PP) | |
| Dow Corning | | Dow Corning |
| Xiameter OFS- | | |
| 6300 silane | | |
| Luperox 101 | polymer initiator | Arkema |
| dodecylbenzene | | Sigma-Aldrich |
| sulfonic acid | | |
| (DBSA) | | |

Notes for Table I:
⁽¹⁾PCN-727 is the name for an experimental product including a mixture of: (a) 98 wt % ENGAGE ™ 8200; (b) 1.90 wt % Dow Corning Xiameter OFS-6300 silane; and (c) 0.1 wt % Luperox 101 totaling 100 wt % material.

All experimental dispersions used herein were prepared on a 40 mm twin screw extruder (L/D=44) on a mechanical dispersion line.

The composition and process details for various dispersions are described in the following Table II.

TABLE II
Dispersions

| | | Inv. Ex. 1 | |
|---|---|---|---|
| Component | Units | (HYPOD 8510) | Inv. Ex. 2 |
| ENGAGE ™ 8200 | % | 60 | — |
| PCN-727 | wt % | — | 40 |
| ENGAGE ™ 8407 | wt % | — | 20 |
| PRIMACOR 5980I | % | 40 | 40 |
| Base Used | | KOH | KOH |
| Degree of | % | 84.9 | 100 |
| Neutralization | | | |
| Process Parameter | | | |
| Screw RPM | | 1150 | 1100 |
| Extruder Pressure | psi | 325 | 410 |
| Extruder Outlet | ° C. | 99 | 99 |
| Temperature | | | |
| Dispersion | ° C. | 26 | 40 |
| Temperature | | | |
| Extruder Amps | amps | 79 | 94 |
| Product Characteristics | | | |
| Mean Particle Size | micron | 1.34 | 1.99 |
| pH | | 10.07 | 13 |
| Viscosity (20 rpm) | cP | 228 | 169 |
| Solids | wt % | 40.57 | 39 |
| Filterable Residue | ppm | 26 | 78 |

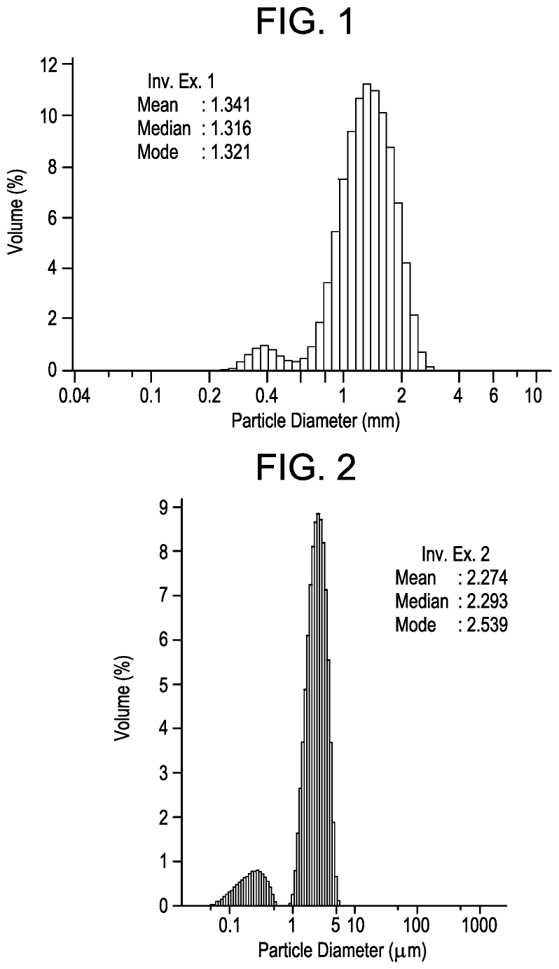

The dispersions for Inv. Ex. 1 and Inv. Ex. 2 are dispersions of silane grafted Engage and are described in Table II above. The particle size and particle distribution of the dispersions described in Table II above is shown in FIG. 1 for Inv. Ex. 1 and FIG. 2 for Inv. Ex. 2. The mean particle size is 1.3 μm for Hypod™ 8510; and the mean particle size is 2.3 μm for the dispersion of Inv. Ex. 2.

### General Procedure for Curing Process

For silane grafted or silane copolymer based dispersions; moisture cure was carried out by blending the dispersion with 0.5 wt % of DBSA and curing for 48 hours (hr) at room temperature (about 25° C.).

### Measurement of Gel Content

The gel content of the dispersions is measured using the procedure described in ASTM D2765. An approximately (˜) 300 mg sample is boiled for 6 hr in decalin at a temperature of from 189° C. to 190° C.; and then the resulting sample is dried overnight in a vacuum oven at 50° C. The insoluble fraction of the sample is the gel content. The gel content is an indication of the amount of curing or crosslinking achieved.

### General Procedure for Measuring Extensional Viscosity

Extensional viscosity (EVF) curves were obtained by stretching a thin polymer film sample using a dual drum wind-up device (available from TA Instruments). Strips were cut from the extrude sheet (6 mm wide, 20 mm long). The samples were compressed to 1 mm thickness. The wind-up device was fitted inside the environmental chamber of an ARES instrument (TA Instruments) and the temperature controlled to the desired target (e.g. 160° C.) by the flow of hot nitrogen. As the drums were counter-rotated at the appropriate angular velocity, a constant Hencky strain of 1.0 s⁻¹ was obtained. The time dependent stress was determined from the measured torque and the sample time depended cross section. Extensional viscosity was plotted as a function of time or Hencky strain. EVF is a good measure of melt strength.

### General Procedure for Coagulation Process

The cured dispersion was converted to powder by a coagulation process following the steps of the process described below.

Step 1. Prepare a diluted dispersion by mixing the dispersion with deionized water (DI) in a 5 gallon (18.9 liter) bucket.

Step 2. Prepare a coagulant solution by dissolving CaCl₂ in DI water in a 5 gallon bucket.

Step 3. Heat the diluted dispersion and the coagulant solution to a coagulation temperature of about 90° C. in a convection oven.

Step 4. Once the solutions are equilibrated, pour the diluted polyolefin dispersion slowly into the coagulant solution while mixing with a bucket mixer.

Step 5. Allow the coagulated mixture to cool to a temperature below 60° C.

Step 6. When the coagulated mixture is below 60° C., start dewatering the mixture using a separating funnel (e.g., a Buchnel funnel with a fine filter).

Step 7. Slowly pour the coagulated mixture into the Buchnel funnel while a vacuum is applied with an aspirator to form a filtered cake.

Step 8. Allow the filtered cake to build up and dry while under vacuum.

Step 9. Remove the dry filtered cake from the funnel, after ˜2 hr of vacuum drying, and place the dry filtered cake on a pan.

Step 10. All the wet powder to dry overnight in a convection oven at 90° C.

### Thermoforming Setup

A lab scale thermoforming setup was used. Sheets were heated in a Proveyor IR oven which has infrared heaters on the top and bottom with independent settings (1-10). Typical conditions were top heater set to 7 and the bottom set to 8. The time in the oven and the temperature just after heating were recorded.

### EXAMPLE 1

### Ebeam Curing

The dispersion used was HYPOD 8510—aqueous dispersion of ENGAGE 8200 elastomer. The Ebeaming was done on Ebeam Services, Lebanon, Ohio. The Ebeam dosage was set at 2 Mrad. Both aqueous dispersion and spray dried powder was placed in trays onto a continuous conveyor system with a ˜8 min residence time through the Ebeam system. A total of 6 passes were done (12 Mrad total). In each pass, the dispersion heated up (˜44° C.). The crosslinking level achieved after Ebeaming was ˜15% for the dispersion and 20% for the dried powder (as measured by gel level method D2765). The Ebeam dispersion was isolated into powder by first coagulating by treatment with salt followed by drying. Although gel level was relatively low, the Ebeam powder showed good thermal stability when heated to >150° C. (no obvious melting of the powder)

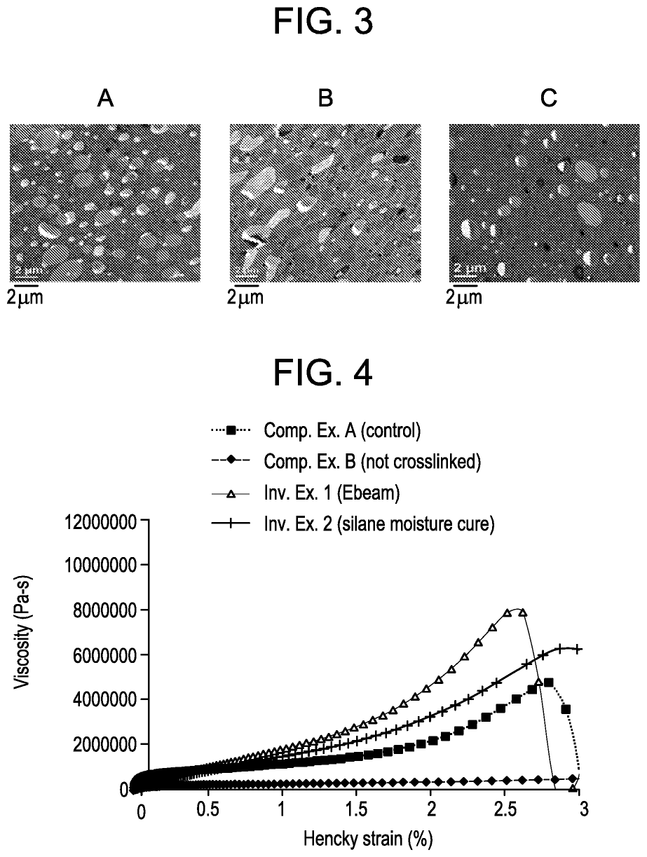

ENGAGE DA50 is high melt strength (HMS) elastomer used in automotive flooring application. The material processes and thermoforms well but typically exhibits high gloss during positive thermoforming. This was used as a control to see the effect of introducing crosslinked particles into the product. The Ebeam beads were compounded in ENGAGE DA50 (at 30% wt level) on a 25 mm twin screw extruder run at 15 lb/hr, 200° C. and 1000 rpm. The ENGAGE DA50 pellets and Ebeam dispersion powder were blended and fed into the feed throat. For comparison purposes, DA50 was also blended with the neat ENGAGE 8200 resin and also coagulated dispersion HYPOD 8510 (not crosslinked) at 30% wt level. The processing pressures are reported in Table IV. The extrusion processes drops with the use of neat ENGAGE 8200. This is to be expected since it a higher flow (5 MFR) compared to ENGAGE DA50 (0.5 MFR). ENGAGE DA50 with 30% coagulated dispersion based on ENGAGE 8200 (HYPOD 8510) has similar processing as the base resin ENGAGE DA50. The dispersion 1 μm particle has a neutralized PRIMACOR shell that is thermally stable. However, the core is not crosslinked and will melt under the processing conditions. TEM (transmission electron microscope) images below shed light on the morphology of the dispersed ENGAGE 8200 particles (FIG. 3). The ENGAGE DA50 control has 25% polypropylene (bright phase). The ENGAGE elastomer phase will stain as a darker phase. ENGAGE 8200/ENGAGE DA50 sample (C) does not show a distinct elastomer particle since the two resins are inherently miscible. ENGAGE DA50 with the Ebeam (crosslinked) dispersion shows a distinct 1 μm spherical domain (B) consistent with the particle size in the starting dispersion. The crosslinked particles are very nicely dispersed demonstrating the effectiveness of this invention. This confirms that after the cured dispersion is converted to powder and then compounded, the original particle is achieved in the compounded product. ENGAGE DA50 with the uncured dispersion (A) shows very diffuse particles showing the thermally stable shell can break up during processing allowing the ENGAGE 8200 core to mix with the base resin.

Compounded samples were sheet extruded on a 1.5-inch Killion single screw extrusion line. A 12-inch coat hanger die was used to produce sheet with a thickness of ˜1.8 mm. A three-roll stack with a top roll containing a hair cell grain was used to emboss the film with ˜170 μm deep grain. Basic run conditions are described in Table III. The pressures seen during the sheeting process are reported in Table IV.

Sheets were heated in an IR oven with the top heater set to 7 and the bottom heater set to 8. The time in the oven and the temperature just after heating were recorded. One minute and fifteen seconds in the oven heated the sheet to approximately 190° C. The sheet was then thermoformed in a wooden mold. The sheet was placed on the mold, covered, and a vacuum was applied. Gloss was recorded before and after thermoforming and is reported in Table IV.

TABLE III
Run Conditions for Killian Sheet Line

| | Set Point (° F.) | |
|---|---|---|
| Zone 1 | 390 | |
| Zone 2 | 400 | |
| Zone 3 | 430 | |
| Clamp Ring | 425 | |
| Die 1 | 428 | |
| Die 2 | 425 | |
| Die 3 | 426 | |
| Extruder RPM | 38 | |
| Roll Stack | 100/90/75° F. | |
| (Top/Middle/Bottom) | | |
| Width | 12 | inches |
| Line Speed | 1.15 | ft/sec |

The 60° gloss of the control ENGAGE DA50 sheet is 1.6-1.8. The sample with the neat ENGAGE 8200 processed poorly and was very glossy. The sample with the uncured dispersion had similar gloss and processing behavior as the control ENGAGE DA50. The 30% Ebeam dispersion sample was significantly lower gloss at 0.7. After thermoforming, the control sample glossed up significantly to 3.3. The sample containing 30% Ebeam dispersion showed minimal gloss up (1.1) and significant grain retention. The comparative sample with uncured dispersion also glossed up to 2.6-2.9. This illustrates the importance of curing the particle to improve melt strength and impart grain retention capability and low gloss. The improved melt strength is confirmed with the extensional viscosity (EVF) data shown in FIG. 4. The control ENGAGE DA50 sample has some degree of melt strength but the introduction of cured dispersion beads (Ebeam or silane) significantly improves extensional viscosity which also increases as a function of Hencky strain. In comparison, the use of neat ENGAGE 8200 significantly reduces extensional viscosity which does not increase as a function of Hencky strain. For thermoforming applications, it is desired that the elongational viscosity increases as the strain rate increases. Many parts may experience draw during thermoforming of up to 100% (1 Hencky strain). If the viscosity does not increase significantly as the part draws, then local thinning or tearing can occur in high draw areas.

TABLE IV
Formulations and Test Results

| | Example No. | | | | |
|---|---|---|---|---|---|
| | Comp. | Comp. | Comp. | | Inv. |
| | Ex. | Ex. A | Ex. B | Inv. | Ex. 2 |
| | Control | Neat dispersed | Elastomer via | Ex. 1 | Dispersion |
| | No | elastomer. | dispersion. | Dispersion | Silane |
| | dispersed | No dispersion. | No | Ebeam | Moisture |
| Sample Description: | elastomer. | No crosslinking. | crosslinking. | Crosslinking. | Crosslinking. |
| COMPONENT | | | | | |
| ENGAGE DA50 | 100 | 70 | 70 | 70 | 70 |
| ENGAGE 8200 | | 30 | | | |
| HYPOD 8510 | | | 30 | | |
| Coagulated Powder | | | | | |
| Ebeam HYPOD 8510 | | | | 30 | |
| Coagulated Powder | | | | | |
| Inv. Ex. 2 Coagulated | | | | | 30 |
| Powder | | | | | |
| Black Colorant | 3 | 3 | 3 | 3 | 3 |
| TEST RESULTS | | | | | |
| Extrusion Pressure | 635 | 630 | 700 | 800 | 850 |
| (psi); 25 mm TSE | | | | | |
| Sheet Extrusion | 700 | 650 | 720 | 1480 | 1350 |
| Pressure (psi) | | | | | |
| Sheet Gloss | 1.6-1.8 | Poor melt strength. | 1.5-1.7 | 0.7 | 1.0-1.1 |
| | | Cannot pick up grain. | | | |
| | | Very glossy (15-20) | | | |
| Gloss after | 3.3 | NA | 2.6-2.9 | 1.1 | 1.5 |
| thermoforming | | | | | |

Notes for Table IV:
Inv. Ex. 1 and Inv. Ex. 2 show significant improvement in melt strength (extensional viscosity), low sheet gloss; good grain retention, and low gloss up.

### EXAMPLE 2

### Silane Grafted ENGAGE

A dispersion of the silane grafted ENGAGE™ (PCN727) was prepared through the BLUEWAVE™ dispersion process. The mean particle size was ˜2.3 μm. The processing conditions to make the dispersion are reported earlier. The dispersion was cured with DBSA at 0.5 wt % (2 days at room temp). The cured dispersion was coagulated with the procedure outlined above. The gel level of the cured powder was 70%.

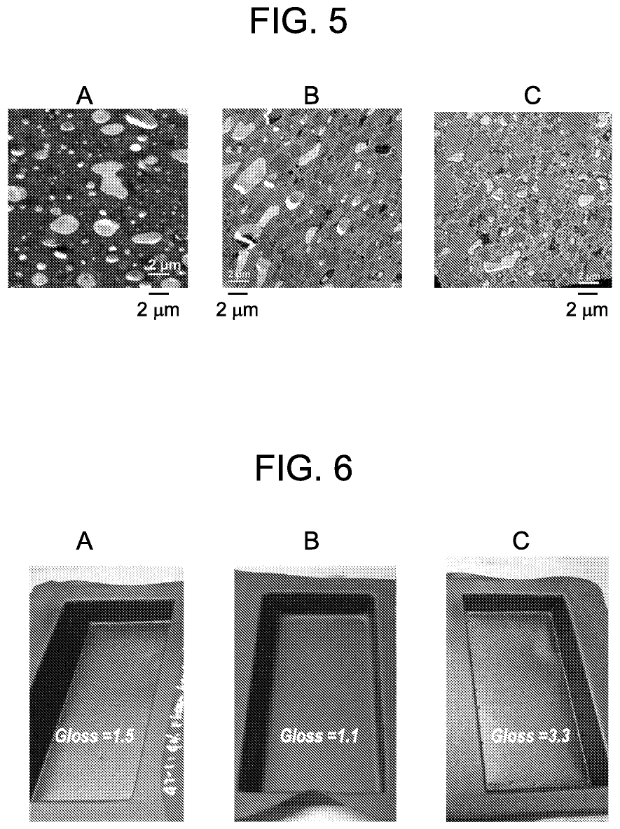

The powder was subsequently compounded into ENGAGE DA50 at 30 wt % in a 25 mm twin screw extruder. TEM microscopy (FIG. 5) shows that the particle size after compounding was in the primary particle range (˜2.3 μm) (C) similar to the Ebeam case where the primary particle size was ˜1.3 μm (B). In both case the dispersion of the particles is excellent. The picture on the left (A) shows the phase morphology of the control (ENGAGE DA50) material, which contains 25 wt % PP and the dispersed PP particles can be clearly seen (bright phase). The picture on the right (C) shows the morphology of the inventive sample (ENGAGE DA50+30% silane beads). The primary particle size is larger (˜2.3 μm) than the Ebeam beads but comparable to the starting primary particle size in the dispersion (FIG. 2). The darkness of the particles is related to the level of curing achieved in the particles. A higher level of curing was achieved in the silane beads. The Ebeam bead sample in the middle (B) shows a dispersed bead size of ˜1.3 μm; again, comparable to the primary particle size in the dispersion.

Compounded samples were sheet extruded on a 1.5-inch Killion single screw extrusion line. Sheets were heated in a Proveyor IR oven with the top heater set to 7 and the bottom set to 8. One minute and fifteen seconds in the oven heated the sheet to approximately 190° C. The sheet was then negatively thermoformed in a wooden mold. The 60 degree gloss of the extruded sheet was 1.0-1.2 compared to the control at 1.6-1.8. The Ebeam sheet was at 0.7 gloss level. The lower gloss with the Ebeam particles can be attributed to the smaller particle size achieved during the dispersion process.

The gloss after thermoforming is shown in FIG. 6. The control ENGAGE DA 50 (C) glossed up significantly (3.3) compared to the sample with 30% silane beads (A) (1.5 gloss) and 30% Ebeam beads (B) (1.1 gloss). FIG. 6 illustrates the differences in the gloss. The grain retention was better with the silane cured sample and this can be attributed to the higher degree of cure. However, the larger particle size offsets that in the gloss. Ideally a small particle size and high degree of curing is desired.

1. An aqueous composition for forming crosslinked polyolefin particles of micron or submicron size dispersed in an aqueous phase comprising:
(i) water for forming an aqueous phase;
(ii) a polyolefin polymer; and
(iii) a curing agent for crosslinking the polyolefin polymer to form polyolefin-particles of micron or submicron size dispersed in the aqueous phase of component (i).

2. The composition of claim 1, wherein the polyolefin is silane grafted or silane copolymer polyolefin; and moisture curing occurs with a catalyst.

3. The composition of claim 1, wherein the curing step (iii) occurs via a radical process using peroxide, Ebeam or a UV process.

4. (canceled)

5. (canceled)

6. (canceled)

7. A process for producing a powder material of dried crosslinked polyolefin particles of micron or submicron size comprising the steps of:
(A) admixing:
(i) water for forming an aqueous phase;
(ii) a polyolefin polymer; and
(iii) a curing agent for crosslinking the polyolefin polymer;
(B) crosslinking the polyolefin polymer of component (ii) using the curing agent of component (iii) to form a concentration of crosslinked polyolefin particles of micron or submicron size dispersed in the aqueous phase of component (i); and
(C) drying the crosslinked polyolefin particles of micron or submicron size of step (B) to provide a material of dried crosslinked polyolefin particles in powder form.

8. (canceled)

9. (canceled)

10. A thermoplastic vulcanate-like polymeric composition comprising an admixture of:
(I) at least one polymer polyolefin; and
(II) a powder material of dried crosslinked polyolefin particles of submicron size.

11. (canceled)

12. (canceled)

13. (canceled)

14. (canceled)
